(19) United States
(12) Patent Application Publication
(10) Pub. No.: US 2022/0413821 A1
(43) Pub. Date: Dec. 29, 2022

(54) DEPLOYING A MACHINE LEARNING MODEL

(71) Applicant: INTERNATIONAL BUSINESS MACHINES CORPORATION, Armonk, NY (US)

(72) Inventors: Lukasz G. Cmielowski, Krakow (PL); AMADEUSZ MASNY, Bialystok (PL); Daniel Jakub Ryszka, Krakow (PL); Wojciech Jakub Jargielo, Bilgoraj (PL)

(21) Appl. No.: 17/304,885

(22) Filed: Jun. 28, 2021

(51) Int. Cl. G06F 8/60; G06N 20/00; G06F 9/54; H04L 29/06

(52) U.S. Cl. CPC G06F 8/60; G06N 20/00; G06F 9/541; H04L 67/42; G06F 2209/541

(57) ABSTRACT

A method, computer system, and a computer program product for deploying at a client system a machine learning model is provided. The present invention may include requesting, from a training system, information on a training environment in which a machine learning model was trained. The present invention may include determining a compatibility of a local environment of a client system with the training environment of the training system based on the information on the training environment. The present invention may include determining the local environment of the client system is compatible with the training environment of the training system. The present invention may include downloading the machine learning model.

### BACKGROUND

The present invention relates generally to the field of computing, and more particularly to a method for deploying a machine learning model.

Machine learning models are being integrated in many software systems such as database transaction processing systems. These models may be very complex to implement and may require many libraries. The execution and results of such models may depend on the libraries and their versions.

### SUMMARY

Embodiments of the present invention disclose a method, computer system, and a computer program product for deploying at a client based system a trained a machine learning model by transferring the trained machine learning model and/or artificial intelligence model from a web-based service computer system to a private computing system. Advantageous embodiments may be described in the dependent claims. Embodiments of the present invention can be freely combined with each other if they are not mutually exclusive.

In an embodiment, the present invention may include requesting, from a training system, information on a training environment in which a machine learning model was trained. The present invention may include determining a compatibility of a local environment of a client system with the training environment of the training system based on the information on the training environment. The present invention may include determining the local environment of the client system is compatible with the training environment of the training system. The present invention may include downloading the machine learning model.

In an embodiment, the present invention may include training a machine learning model. The present invention may include creating metadata indicative of a training environment of a training system. The present invention may include linking the metadata to the trained machine learning model. The present invention may include providing an application program interface (API) service for enabling at least access to the metadata before downloading the trained machine learning model and downloading the trained machine learning model.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a block diagram of a computer system in accordance with an example of the present subject matter;

FIG. 2 is an example of metadata descriptive of the environment in which a machine learning model is built;

FIG. 3 is a flowchart of a method for deploying a machine learning model in accordance with an example of the present subject matter;

FIG. 4 is a flowchart of a method for providing trained machine learning models in accordance with an example of the present subject matter;

FIG. 5 is a flowchart of a method for deploying a machine learning model in accordance with an example of the present subject matter;

FIG. 6 represents a computerized system, suited for implementing one or more method steps as involved in the present subject matter;

FIG. 7 depicts a cloud computing environment according to an embodiment of the present invention; and

FIG. 8 depicts abstraction model layers according to an embodiment of the present invention.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Users may need to download trained models to be able to access the trained models to do additional validation, refinery and serving on their own infrastructure. However, machine learning models are often created using 3^{rd} party libraries in strict release versions. Those libraries may not be available by default in every system and may not guaranty backward compatibility e.g., if a model has been trained with scikit-learn version 0.19 and the client system has scikit-learn version 0.23, the trained model may not be executable on the client system. This problem may get even more complex when the model is based on multiple 3^{rd} party libraries. This problem may render the deployment of machine learning models a challenging task because the software deployment may require a knowledge of the environment in which the machine learning model has been built. Deployment of a machine learning model may be a process of installing the machine learning model in the client system from the training system. A solution to the above mentioned problem may involve multiple experts trying to determine whether a trained machine learning model is deployable or not deployable in the client system. However, this procedure may be very prone to errors and resource consuming e.g., the procedure may require a very long time until the machine learning model is determined to be deployable in particular for complex computing environments. Another solution may be closed environments such as containers with hard-coded version of libraries; however, this solution may not be a reliable solution for multiple machine learning models. In particular this solution may require an independent container package for each model, which may result in a waste of a lot of hardware resources. The present subject matter may solve the problem and overcome the drawbacks of the above solutions, by using metadata descriptive of the environment in which the machine learning models are built in order to provide a local compatible environment for deployment of the machine learning models. The deployment of the trained machine learning model may make the trained machine learning model available for use at the client system. This may enable successful processing of machine learning models in local systems. This may particularly be advantageous as software deployment may be a crucial first step for a successful local inference of machine learning models at the client system.

The training environment may be an execution environment in which the training of a machine learning model takes place. The local environment may be an execution environment in which the inference of a machine learning model takes place. The execution environment may refer to software components used to execute the training or the inference. An example of a software component may be an operating system such as UNIX, programing language component such as python, a library such as numpy etc. The software component may have a version number. That is, an execution environment may be defined by a set of software components and versions of the set of software components. The local environment is compatible with the training environment if the local environment comprises the set of software components of the training environment and has the same versions of the set of software components of the training environment.

The client system may, for example, be an on-premise system and the training system may, for example, be an off-premise system. The on-premise system may be a local system on the premises of a user or organization for executing on-premise software. The off-premise system may be a remote system that is accessible e.g., by the user of the on-premise system, via a network and that may be owned by a third party. The on-premise system and the off-premise system may be provided in accordance with different configurations. For example, the configuration may be a client server configuration in which the on-premise system may represent the client side and the off-premise system may represent the server side of this configuration. In another example, the configuration may be a cloud configuration in which the off-premise system may be in a public or private cloud and the on-premise system may be a non-cloud-based system.

According to one embodiment, the client system is configured in a client-server configuration with the training system. The training system provides the machine learning model and said information on the training environment as a service for the client system. The service may be a collection of resources and a set of methods that can be used to manipulate the resources. The methods may be executed in a given order e.g., the method for requesting the information on the trained model may be executed before being able to execute the method for downloading the trained model. Each resource may be represented in a format such as JavaScript Object Notation (JSON) or Extensible Markup Language (XML) format. For example, to retrieve the metadata, the client system can specify a resource name along with a method in a request, and send the request to the training system; the training system may then return the requested resource to the client system in the specified format.

According to one embodiment, the service is provided by an application programming interface (API) service. The method further comprises: downloading at the client system an API package that enables access to the API service, wherein the requesting, adapting and downloading are performed using API functions of the API package. The API service may provide functions that enable to use the service of the training system. The API service may, for example, define the format of the request to be performed by the client system. For example, the API may provide or expose two methods that can be called by the client system. A first method of the two methods may be used to get information about the model (e.g., the first method may be called as follows: optimizer.get_details(pipeline_name)) and a second method of the two methods may be used to get/download the model (e.g., the second method may be called as follows optimizer.get_pipelines(pipeline_name)). All the checks of compatibility may be done automatically under the hood of the second method “get_pipelines”. This second method may get the software information, gather the local runtime information, checks for incompatibilities and informs the user. If needed it can also be extended to upgrade/downgrade incompatible libraries.

According to one embodiment, the API package is downloaded from a public repository. This may be advantageous as the API package may be used by multiple client systems that require the machine learning models of the training system.

According to one embodiment, the machine learning model is received as a binary file. The fact that it is received in binary format may render difficult if not impossible to find the environment in which the model has been trained. The present subject matter may enable the use of binary files as it provides additional information on the training environments. This may be advantageous as it may seamlessly be integrated with existing systems that provide trained models as binary files.

According to one embodiment, the machine learning model is persisted in accordance with a persistence model of the training system. The persistence model comprises a pickle persistence model.

According to one embodiment, the training environment is defined by a list of libraries required during the training of the machine learning model and their release numbers. The determining whether the local environment is compatible with the training environment comprises determining whether each library of the list of libraries is installed in the local system and/or whether release numbers of the installed libraries are the same as the release numbers of the training environment, wherein adapting the local environment comprises installing uninstalled libraries and/or changing the installed libraries for downgrading or upgrading the release numbers of the installed libraries.

According to one embodiment, the client system is remotely connected to the training system via a communication network. According to one embodiment, the training system is in a cloud service environment.

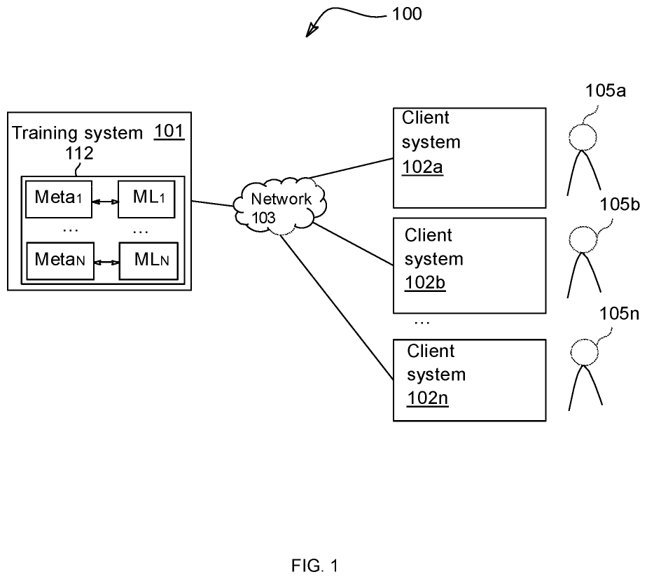

FIG. 1 illustrates a computer system 100 in accordance with an example of the present subject matter. The computer system 100 comprises a training system 101 and one or more client systems 102a-n. The training system 101 may be configured to communicate with each of the client systems 102a-n via one or more networks 103. For simplification of the description only one network is shown; however, the training system 101 may connect to the client systems 102a-n via more than one network e.g., the training system 101 may connect to each of the computer systems 102a-n via a respective network. For example, the network 103 may include, but is not limited to, a cable network, an optical fiber network, a hybrid fiber coax network, a wireless network (e.g., a Wi-Fi and/or mobile telephone network), a satellite network, the Internet, an intranet, a local area network, any other suitable network, and/or any combination of these networks.

As shown, a user 105a-n may be associated with the computer systems 102a-n respectively. The user 105a-n may include a viewer, owner, support technician etc. The user 105a-n may use a workstation (not shown) in order to interact or communicate with the client system 102a-n and the training system 101. The training system 101 may be provided as a single server device or multiple server devices operating in a cloud computing configuration.

The training system 101 may be remote to the client systems 102a-n, accessible over the network 103. The training system 101 may provide resources for training, running and storing machine learning models. The training system 101 may, for example, comprise a storage system 112 for storing N trained machine learning models ML₁ . . . ML_{N}, where N≥1. Storage system 112 may further store metadata Meta₁ . . . Meta_{N} associated or linked with the machine learning models ML₁ . . . ML_{N} respectively. Each of the metadata Meta₁ . . . Meta_{N} may be provided as a document such as a JSON file. The linkage between each trained model and the document describing environment packages used to train it may be provided by the training system 101.

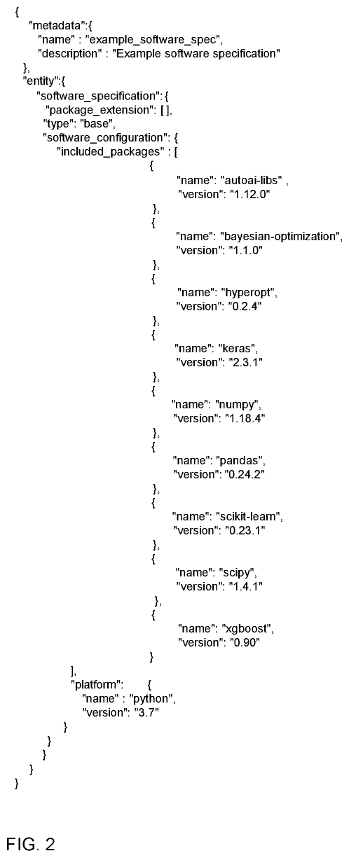

The metadata Meta₁ . . . Meta_{N} may, for example, be exposed by the service of the training system 101 to a python API run on the client systems 102a-n. FIG. 2 shows an example document presenting one of the metadata Meta₁ . . . Meta_{N}. It shows a list of packages used to train a model and their versions. The metadata of the produced model may be extended by adding link/name of a pre-defined software specification. The document of FIG. 2 is called software specification. The document may be used to link a produced machine learning model with the pre-defined software specification version. The document contains the list of all dependent packages required during the training process and their releases numbers. In case there is an upgrade on training image site, the document may either be updated (if no braking changes introduced) or a new version of it may be provided.

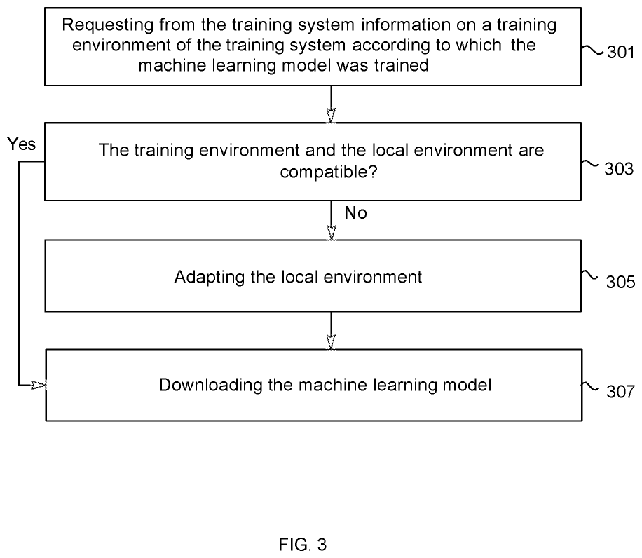

FIG. 3 is a flowchart of a method for deploying at a client system a machine learning model that has been trained in a training system. For the purpose of explanation, the method described in FIG. 3 may be implemented in the system illustrated in FIG. 1, but is not limited to this implementation. The method of FIG. 3 may, for example, be performed by one of the client systems 102a-n in order to deploy the machine learning model ML₁. The model ML₁ may be trained in a training system that is a closed environment like a cloud service and may not be exposed explicitly to end users as machine learning model objects. For example, the model ML₁ may be stored on the training system as a pickled joblilb object. Since the model is stored as pickled joblilb object it may be made available to end users outside the cloud service. A jupyter notebook server may, for example, be set up at the client system e.g., to perform at least part of the method.

The client system may request in step 301 from the training system 101 information on a training environment of the training system 101 that has been used to train the machine learning model ML₁. For that, a python package may, for example, be used. The python package (API) may be exposed on a public repository. The python package may act like a python client allowing for interaction with assets produced on the training system. The python client provides methods such as a method to get information about the model ML₁ (e.g., the method may be called as follows: optimizer.get_details(pipeline_name)) and such as a method to get/download the model ML₁ (e.g., the second method may be called as follows optimizer.get_pipelines(pipeline_name)). The python package may provide the functionality of download and load of trained model ML₁. The package may be used on the client system in both user provided code and also auto-generated notebooks. The notebook-generator may, for example, inject the python package installation command.

The client system may receive the requested information and may determine (inquiry step 303) whether a local environment of the client system is incompatible with the training environment as defined in the received information. The information may, for example, comprise a list of libraries or packages and their respective versions (which may be named listed libraries and listed versions). For example, the client system may receive the requested information as the JSON file described with reference to FIG. 2. The client system may determine in step 303 whether each of the listed libraries in the received information is installed in the client system. And if a library of the listed libraries is already installed at the client system, the client system may further determine whether the installed library has the same version or release as the listed version of the library. If one or more libraries are not installed and/or one or more installed libraries do not have the same versions as the respective listed versions, this may indicate that the local environment is incompatible with the training environment. Following the above example, all these checks of compatibility may be done automatically under the hood of the method “get_pipelines”. This method may get the software information, gather the local runtime information, checks for incompatibilities and informs the user. If needed it can also be extended to upgrade/downgrade incompatible libraries.

In case the client system determines that the local environment is compatible with the training environment, step 307 may be performed. In case the client system determines that the local environment is incompatible with the training environment, the client system may adapt in step 305 the local environment for obtaining the compatibility between the local environment and the training environment. Depending on what caused the incompatibility, the client system may install uninstalled libraries and/or upgrade/downgrade the versions of installed libraries to match the versions of the listed libraries. After updating the local environment, step 307 may be performed

The client system may download in step 307 the machine learning model from the training system. This may enable the user to work with the machine learning model ML₁ in the same mode as it was trained in local environment/runtime.

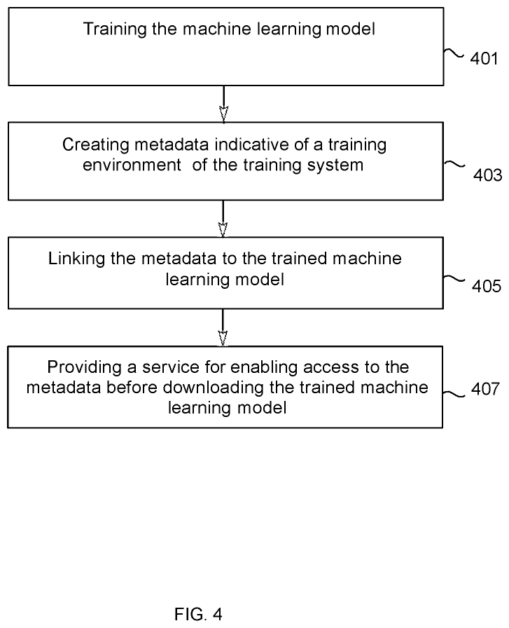

FIG. 4 is a flowchart of a method for providing a trained machine learning model. For the purpose of explanation, the method described in FIG. 4 may be implemented in the system illustrated in FIG. 1 but is not limited to this implementation. The method of FIG. 4 may, for example, be performed by the training system 101.

The training system 101 may train in step 401 a machine learning model. The machine learning model may, for example, be written in a programming language such as python. The training of the machine learning model may require one or more libraries in order to be executed. For example, the execution of the machine learning model may require pandas library for creating data structures and for manipulating numerical tables and time series. Each of the libraries may have a release or version number.

The training system 101 may create in step 403 metadata indicative of a training environment of the training system that is used to train the machine learning model. The training environment may for example be defined by the libraries and their respective versions as used to train the machine learning model. The metadata may be provided, for example, as a JSON file as shown in FIG. 2.

The training system 101 may link in step 405 the created metadata to the trained machine learning model. This may, for example, be performed by including the name of the machine learning model in the JSON file.

The training system 101 may provide in step 407 a service for enabling access (e.g., to the client systems 102a-n) to the metadata before downloading the trained machine learning model. The service may be a collection of resources and a set of methods that can be used to manipulate the resources. For example, the metadata may be provided as a resource and the trained machine learning model may be provided as a resource. The metadata resource may be represented in a JSON or XML format. For example, to retrieve the metadata, the client system can specify a resource name along with a method in a request, and send the request to the training system; the training system may then return the requested resource to the client system in the specified format.

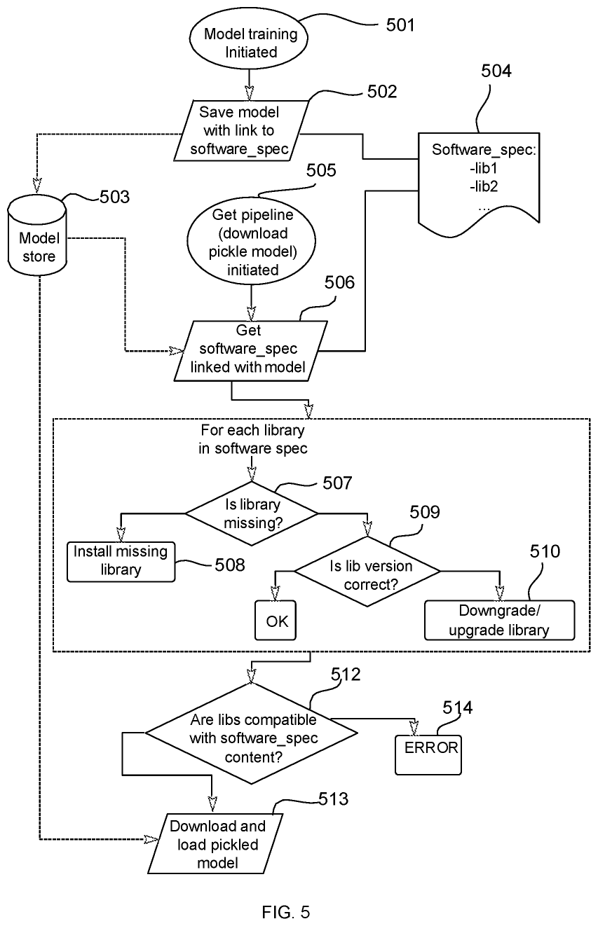

FIG. 5 is a flowchart of a method for deploying machine learning models. The model training may be initiated in step 501. The trained model may be saved in step 502 in a model store 503. The trained model may be stored with a link to a metadata (e.g., named software_spec) descriptive of the environment used to train the model. The trained model may be stored or persisted as a pickle model. As shown in FIG. 5, the metadata 504 may indicate the libraries used to train the model. Steps 501 to 502 may, for example, be performed at the training system 101. In step 505, a get pipeline may be initiated e.g., at the client system 102a, in order to download the trained model. In step 506, the client system may request using “Get” method the metadata 504 from the training system 101 and may receive the requested metadata 504. For each library of the libraries in the metadata 504, steps 507 to 510 may be performed. In step 507 it may be determined if the library is missing from the client system. If the library is missing, it may be installed in step 508 in the client system. If the library is not missing e.g., already installed at the client system, the client system may determine in step 509 whether the installed library has the correct version i.e., whether the installed library has the same version as the library indicated in the received metadata 504. If the version of the library is not the correct one, the library may be downgraded or upgraded in step 510 to match the version of the corresponding library in the metadata 504. In one example, the execution of step 510 may or may not be optional. For that, the automatic execution of step 510 may be controlled based on a value of a flag “automatic_update=False or True”. This may be advantageous as the user may like to prevent automatic execution of step 510, e.g., if the user has an environment configured for other purposes. Based on the checks performed in steps 507 and 509 it may be determined in step 512 whether the libraries in the client system are compatible with the libraries listed in the metadata. If they are compatible, the trained model may be downloaded in step 513 at the client system. If there is no compatibility, an error message may be provided in step 514. Step 514 may advantageously be provided in case step 510 is not executed as the error may inform the user and it is up to the user to decide whether to update the local environment and then download the model.

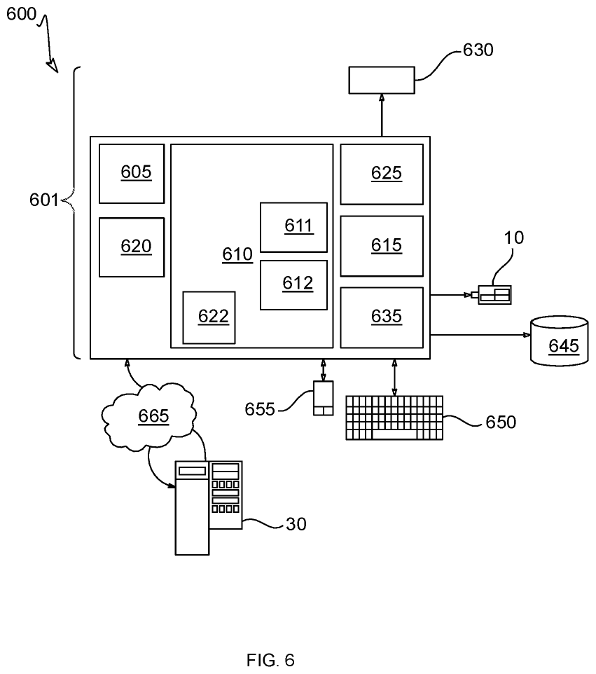

FIG. 6 represents a general computerized system 600 suited for implementing at least part of method steps as involved in the disclosure.

It will be appreciated that the methods described herein are at least partly non-interactive, and automated by way of computerized systems, such as servers or embedded systems. In exemplary embodiments though, the methods described herein can be implemented in a (partly) interactive system. These methods can further be implemented in software 612, 622 (including firmware 622), hardware (processor) 605, or a combination thereof. In exemplary embodiments, the methods described herein are implemented in software, as an executable program, and is executed by a special or general-purpose digital computer, such as a personal computer, workstation, minicomputer, or mainframe computer. The most general system 600 therefore includes a general-purpose computer 601.

In exemplary embodiments, in terms of hardware architecture, as shown in FIG. 6, the computer 601 includes a processor 605, memory (main memory) 610 coupled to a memory controller 615, and one or more input and/or output (I/O) devices (or peripherals) 10, 645 that are communicatively coupled via a local input/output controller 635. The input/output controller 635 can be, but is not limited to, one or more buses or other wired or wireless connections, as is known in the art. The input/output controller 635 may have additional elements, which are omitted for simplicity, such as controllers, buffers (caches), drivers, repeaters, and receivers, to enable communications. Further, the local interface may include address, control, and/or data connections to enable appropriate communications among the aforementioned components. As described herein the I/O devices 10, 645 may generally include any generalized cryptographic card or smart card known in the art.

The processor 605 is a hardware device for executing software, particularly that stored in memory 610. The processor 605 can be any custom made or commercially available processor, a central processing unit (CPU), an auxiliary processor among several processors associated with the computer 601, a semiconductor-based microprocessor (in the form of a microchip or chip set), or generally any device for executing software instructions.

The memory 610 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM). Note that the memory 610 can have a distributed architecture, where various components are situated remote from one another, but can be accessed by the processor 605.

The software in memory 610 may include one or more separate programs, each of which comprises an ordered listing of executable instructions for implementing logical functions, notably functions involved in embodiments of this invention. In the example of FIG. 6, software in the memory 610 includes instructions 612 e.g. instructions to manage databases such as a database management system.

The software in memory 610 shall also typically include a suitable operating system (OS) 611. The OS 611 essentially controls the execution of other computer programs, such as possibly software 612 for implementing methods as described herein.

The methods described herein may be in the form of a source program 612, executable program 612 (object code), script, or any other entity comprising a set of instructions 612 to be performed. When a source program, then the program needs to be translated via a compiler, assembler, interpreter, or the like, which may or may not be included within the memory 610, so as to operate properly in connection with the OS 611. Furthermore, the methods can be written as an object-oriented programming language, which has classes of data and methods, or a procedure programming language, which has routines, subroutines, and/or functions.

In exemplary embodiments, a conventional keyboard 650 and mouse 655 can be coupled to the input/output controller 635. Other output devices such as the I/O devices 645 may include input devices, for example but not limited to a printer, a scanner, microphone, and the like. Finally, the I/O devices 10, 645 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The I/O devices 10, 645 can be any generalized cryptographic card or smart card known in the art. The system 600 can further include a display controller 625 coupled to a display 630. In exemplary embodiments, the system 600 can further include a network interface for coupling to a network 665. The network 665 can be an IP-based network for communication between the computer 601 and any external server, client and the like via a broadband connection. The network 665 transmits and receives data between the computer 601 and external systems 30, which can be involved to perform part, or all of the steps of the methods discussed herein. In exemplary embodiments, network 665 can be a managed IP network administered by a service provider. The network 665 may be implemented in a wireless fashion, e.g., using wireless protocols and technologies, such as WiFi, WiMax, etc. The network 665 can also be a packet-switched network such as a local area network, wide area network, metropolitan area network, Internet network, or other similar type of network environment. The network 665 may be a fixed wireless network, a wireless local area network W(LAN), a wireless wide area network (WWAN) a personal area network (PAN), a virtual private network (VPN), intranet or other suitable network system and includes equipment for receiving and transmitting signals.

If the computer 601 is a PC, workstation, intelligent device or the like, the software in the memory 610 may further include a basic input output system (BIOS) 622. The BIOS is a set of essential software routines that initialize and test hardware at startup, start the OS 611, and support the transfer of data among the hardware devices. The BIOS is stored in ROM so that the BIOS can be executed when the computer 601 is activated.

When the computer 601 is in operation, the processor 605 is configured to execute software 612 stored within the memory 610, to communicate data to and from the memory 610, and to generally control operations of the computer 601 pursuant to the software. The methods described herein and the OS 611, in whole or in part, but typically the latter, are read by the processor 605, possibly buffered within the processor 605, and then executed.

When the systems and methods described herein are implemented in software 612, as is shown in FIG. 6, the methods can be stored on any computer readable medium, such as storage 620, for use by or in connection with any computer related system or method. The storage 620 may comprise a disk storage such as HDD storage.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

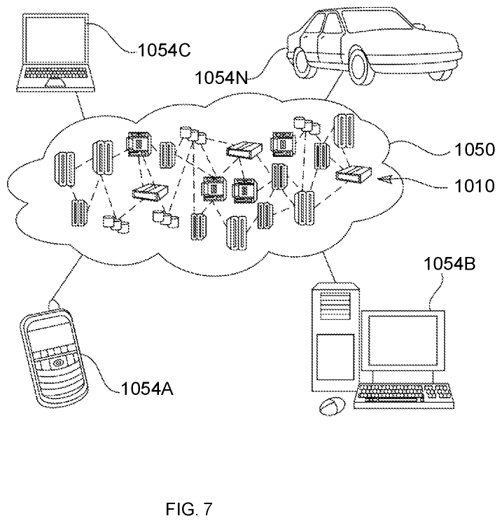

Referring now to FIG. 7, illustrative cloud computing environment 1050 is depicted. As shown, cloud computing environment 1050 includes one or more cloud computing nodes 1010 with which local computing devices used by cloud consumers, such as, for example, personal digital assistant (PDA) or cellular telephone 1054A, desktop computer 1054B, laptop computer 1054C, and/or automobile computer system 54N may communicate. Nodes 1010 may communicate with one another. They may be grouped (not shown) physically or virtually, in one or more networks, such as Private, Community, Public, or Hybrid clouds as described hereinabove, or a combination thereof. This allows cloud computing environment 1050 to offer infrastructure, platforms and/or software as services for which a cloud consumer does not need to maintain resources on a local computing device. It is understood that the types of computing devices 1054A-N shown in FIG. 7 are intended to be illustrative only and that computing nodes 1010 and cloud computing environment 1050 can communicate with any type of computerized device over any type of network and/or network addressable connection (e.g., using a web browser).

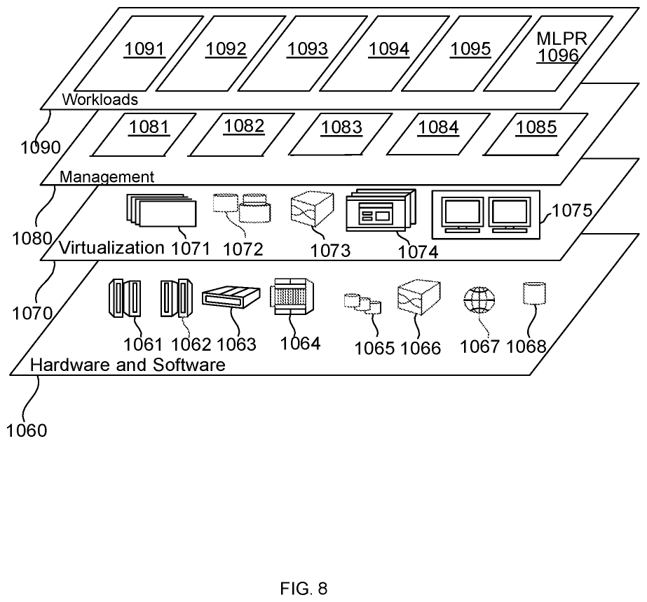

Referring now to FIG. 8, a set of functional abstraction layers provided by cloud computing environment 1050 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 1060 includes hardware and software components. Examples of hardware components include: mainframes 1061; RISC (Reduced Instruction Set Computer) architecture based servers 1062; servers 1063; blade servers 1064; storage devices 1065; and networks and networking components 1066. In some embodiments, software components include network application server software 1067 and database software 1068.

Virtualization layer 1070 provides an abstraction layer from which the following examples of virtual entities may be provided: virtual servers 1071; virtual storage 1072; virtual networks 1073, including virtual private networks; virtual applications and operating systems 1074; and virtual clients 1075.

In one example, management layer 1080 may provide the functions described below. Resource provisioning 1081 provides dynamic procurement of computing resources and other resources that are utilized to perform tasks within the cloud computing environment. Metering and Pricing 1082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1083 provides access to the cloud computing environment for consumers and system administrators. Service level management 1084 provides cloud computing resource allocation and management such that required service levels are met. Service Level Agreement (SLA) planning and fulfillment 1085 provide pre-arrangement for, and procurement of, cloud computing resources for which a future requirement is anticipated in accordance with an SLA.

Workloads layer 1090 provides examples of functionality for which the cloud computing environment may be utilized. Examples of workloads and functions which may be provided from this layer include: mapping and navigation 1091; software development and lifecycle management 1092; virtual classroom education delivery 1093; data analytics processing 1094; transaction processing 1095; and a machine learning model provision (MLPR) 1096 in accordance with the present subject matter e.g., as described with reference to FIG. 4 or 5.

The present subject matter may comprise the following clauses.

Clause 1. A method for deploying at a client system a machine learning model that has been trained in a training system, the method comprising:
requesting from the training system information on a training environment of the training system according to which the machine learning model was trained;
in case a local environment of the client system is incompatible with the training environment adapting the local environment for obtaining the compatibility;
in case the local environment is compatible with the training environment downloading the machine learning model.

Clause 2. The method of clause 1, the client system being configured in a client-server configuration with the training system, the training system providing the machine learning model and said information as a service for the client system.

Clause 3. The method of clause 2, the service being an application programming interface, API, service, the method further comprising: downloading at the client system an API package that enables access to the API service, wherein the requesting, adapting and downloading are performed using API functions of the API package.

Clause 4. The method of clause 3, the API package being downloaded from a public repository.

Clause 5. The method of any of the preceding clauses 1 to 4, the machine learning model being received as a binary file.

Clause 6. The method of any of the preceding clauses 1 to 5, the machine learning model being persisted in accordance with a persistence model of the training system, the persistence model comprising at least one of pickle persistence model.

Clause 7. The method of any of the preceding clauses 1 to 6, the training environment being defined by a list of dependent libraries required during the training of the machine learning model and their release numbers, wherein the determining whether the local environment is compatible with the training environment comprises determining whether libraries of the list of dependent libraries are installed in the local system and/or whether release numbers of the installed libraries are the same as the release numbers of the training environment, wherein adapting the local environment comprises installing uninstalled libraries and/or changing the installed libraries for downgrading or upgrading the release numbers of the installed libraries.

Claus 8. The method of any of the preceding clauses 1 to 7, the client system being remotely connected to the training system via a communication network.

Clause 9. The method of any of the preceding clauses 1 to 8, the training system being in a cloud service environment

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for deploying at a client system a machine learning model, the method comprising:
requesting, from a training system, information on a training environment in which a machine learning model was trained;
determining a compatibility of a local environment of a client system with the training environment of the training system based on the information on the training environment;
determining the local environment of the client system is compatible with the training environment of the training system; and
downloading the machine learning model.

2. The method of claim 1, wherein determining the compatibility of the local environment with the training environment, further comprises:
determining the local environment of the client system is incompatible with the training environment of the training system; and
adapting the local environment of the client system, wherein the local environment of the client system is adapted to be compatible with the training environment of the training system.

3. The method of claim 2, wherein the client system is configured in a client-server configuration with the training system, the training system providing the machine learning model and the information on the training environment as a service for the client system.

4. The method of claim 3, wherein the service is an application programming interface (API) service, further comprising:
downloading, by the client system, an API package that enables access to the API service, wherein at least the requesting, the adapting, and the downloading are performed using API functions of the API package.

5. The method of claim 4, wherein the API package is downloaded from a public repository.

6. The method of claim 1, wherein the machine learning model is a binary file.

7. The method of claim 1, wherein the machine learning model is persisted in accordance with a persistence model of the training system, the persistence model comprising at least a pickle persistence model.

8. The method of claim 2, wherein the information on the training environment includes at least a list of dependent libraries, wherein the list of dependent libraries being comprised of one or more libraries required during training of the machine learning model and release numbers of the one or more libraries.

9. The method of claim 8, wherein determining the compatibility of the local environment of the client system with the training environment, further comprises:
determining whether the one or more libraries of the list of dependent libraries are installed in the client system based on whether the release numbers of the one or more libraries of the list of dependent libraries are the same as release numbers of one or more libraries of the client system.

10. The method of claim 9, wherein adapting the local environment of the client system further comprises:
updating the one or more libraries of the client system, wherein updating the one or more libraries of the client system includes at least, installing uninstalled libraries on the client system and/or downgrading or upgrading the release numbers of the one or more libraries of the client system.

11. The method of claim 1, wherein the client system is remotely connected to the training system via a communication network.

12. The method of claim 1, wherein the training system is in a cloud service environment.

13. A method for training at a training system a machine learning model, the method comprising:
training a machine learning model;
creating metadata indicative of a training environment of a training system;
linking the metadata to the trained machine learning model; and
providing an application programming interface (API) service for enabling at least access to the metadata before downloading the trained machine learning model and downloading the trained machine learning model.

14. The method of claim 13, wherein the API service is in a cloud environment.

15. The method of claim 13, wherein the trained machine learning model is persisted in accordance with a persistence model of the training system, the persistence model comprising at least a pickle persistence model.

16. A computer system for deploying at a client system a machine learning model, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
requesting, from a training system, information on a training environment in which a machine learning model was trained;
determining a compatibility of a local environment of a client system with the training environment of the training system based on the information on the training environment;
determining the local environment of the client system is compatible with the training environment of the training system; and
downloading the machine learning model.

17. The computer system of claim 16, wherein determining the compatibility of the local environment with the training environment, further comprises:
determining the local environment of the client system is incompatible with the training environment of the training system; and
adapting the local environment of the client system, wherein the local environment of the client system is adapted to be compatible with the training environment of the training system.

18. The computer system of claim 17, wherein the information on the training environment includes at least a list of dependent libraries, wherein the list of dependent libraries being comprised of one or more libraries required during training of the machine learning model and release numbers of the one or more libraries.

19. The computer system of claim 18, wherein determining the compatibility of the local environment of the client system with the training environment, further comprises:
determining whether the one or more libraries of the list of dependent libraries are installed in the client system based on whether the release numbers of the one or more libraries of the list of dependent libraries are the same as release numbers of one or more libraries of the client system.

20. A computer program product for deploying at a client system a machine learning model, comprising:
one or more non-transitory computer-readable storage media and program instructions stored on at least one of the one or more tangible storage media, the program instructions executable by a processor to cause the processor to perform a method comprising:
requesting, from a training system, information on a training environment in which a machine learning model was trained;
determining a compatibility of a local environment of a client system with the training environment of the training system based on the information on the training environment;
determining the local environment of the client system is compatible with the training environment of the training system; and
downloading the machine learning model.
